(19) United States
(12) Patent Application Publication
(10) Pub. No.: US 2019/0283628 A1
(43) Pub. Date: Sep. 19, 2019

(54) MOTOR VEHICLE SEAT CUSHIONING

(71) Applicant: CERA TSC, Paris (FR)

(72) Inventors: Santiago Sanchez, Paris (FR); Laurent Georges, Paris (FR); Llius Puig, Paris (FR)

(21) Appl. No.: 16/346,616

(22) PCT Filed: Nov. 5, 2017
(86) PCT No.: PCT/FR2017/053021

§ 371 Date: May 1, 2019

(30) Foreign Application Priority Data
Nov. 4, 2016 (FR) 1660696

(51) Int. Cl. B60N 2/00; B60N 2/70; G01L 1/20

(52) U.S. Cl. CPC B60N 2/002; G01L 1/20; B60N 2/70

(57) ABSTRACT

The invention is motor vehicle cushioning having a cushion and a flexible layer for detecting the presence of an occupant in the seat. The cushioning includes a cap covering the cushion, the cap is mounted on the cushion, covering the layer. The layer is made from an elastically stretchable sheet on which an electric circuit made from conductive ink is printed, the layer being separate from the cap and glued, at least partially, by the underside of the sheet, to the cushion, so as to stretch when the cushion is deformed upon receiving an occupant, and to consequently stretch the circuit in such a way as to increase the electrical resistance of same.

### CROSS-REFERENCE TO RELATED APPLICATION

This application claims the benefit of International application number PCT/FR2017/053021, filed Nov. 5, 2017 and French application number 1660696, filed Nov. 4, 2016 the entire contents of which are incorporated herein by reference.

### TECHNICAL FIELD

The invention concerns a motor vehicle seat cushioning, a motor vehicle seat comprising such a cushioning and a safety unit comprising such a seat.

### BACKGROUND

It is known, in particular from document US2002093236-A1, to produce a motor vehicle seat cushioning, the cushioning comprising:
a padded cushion made from elastically compressible foam,
a flexible layer for detecting the presence of an occupant in the seat, the layer being arranged on the cushion on a face for receiving the occupant, the layer being made from a sheet on which an electric circuit made from conductive ink is printed, the ink being made from conductive particles embedded in an elastically insulating binder, the circuit being intended to be supplied by a generator,
a cap covering the cushion, the cap being mounted on the cushion covering the layer, the cap being provided with return means fastened on reciprocal means secured to the cushion and peripheral fastening means intended to cooperate with reciprocal means outside of the cushioning provided on the seat.

The layer disclosed in this document is provided with a plurality of pressure sensors, making it possible to detect the presence and/or the positioning of the occupant on the cushioning.

Such an arrangement has the disadvantage of being complex and expensive.

That is why, it could be considered, as disclosed for example in document EP2829434-A1, applied on a layer for suspending the seat, to remove the pressure sensors and to utilise the fact that the conductive ink of the circuit has a variable resistance according to the deformation of the suspension layer.

In practice, the more the layer is deformed, i.e. stretched under the effect of the weight of an occupant, the more the particles of the conductive ink are spaced from one another and the more the resistance of the electric circuit increases.

It is thus possible to activate the safety functions of the seat (seatbelt reminder, airbag deployment, etc.) only when it is occupied by an occupant exerting, on the cushioning, a sufficient pressure to bring the resistance of the circuit beyond a threshold value.

However, such that such a principle can be applied, it is necessary that the stretching of the detection layer at best follows the deformation of the face for receiving the padded cushion under the weight of the occupant.

To do this, it could be considered, as described in particular in document LU91866, that the detection layer is integrated with the covering cap.

However, when the cap is mounted on the cushion and fixed by way of return means and peripheral fastening means, as explained above, the cap is tensioned.

It results that a detection layer, provided with a circuit made from conductive ink, which would be integrated with the cap would be, through the tension-mounting of the cap, subjected to an original stretching not caused by the presence of an occupant, the stretching could be different from one cushioning to the other, according to the dimensional dispersions and materials used to produce the cap (fabric, leather, etc.).

A calibration, repeatable and common to all cushioning of the threshold resistance to be applied for an appropriate triggering of the safety functions of the seat could thus not be guaranteed.

### SUMMARY OF THE INVENTION

The present invention aims to propose an arrangement making it possible for the detection layer to have no original stretching in the absence of an occupant, and also for the stretching of the layer to follow, at best, the deformation of the face for receiving the padded cushion under the weight of the occupant.

To this end, and according to a first aspect, the invention proposes a motor vehicle seat cushioning, the cushioning comprising:
a padded cushion made from elastically compressible foam,
a flexible layer for detecting the presence of an occupant in the seat, the layer being arranged on the cushion on a face for receiving the occupant, the layer being made from a sheet on which an electric circuit made from conductive ink is printed, the ink being made from conductive particles embedded in an elastically insulating binder, the circuit being intended to be supplied by a generator,
a cap covering the cushion, the cap being mounted on the cushion covering the layer, the cap being provided with return means fastened on reciprocal means secured to the cushion and peripheral fastening means intended to cooperate with reciprocal means outside of the cushioning provided on the seat,

the cushioning furthermore having the following characteristics:
the sheet is elastically stretchable,
the layer is firstly separate from the cap and secondly glued, at least partially, by the underside of the sheet, to the cushion, to stretch when the cushion is deformed upon receiving an occupant, and to consequently stretch the circuit in such a way as to increase the electrical resistance of same.

In this description, the terms of positioning in space (high, transversal, lateral, front, rear, etc.) are taken in reference to the cushioning mounted in the vehicle.

With the arrangement proposed:
through the elastically stretchable nature of the sheet, the layer is likely to stretch, itself also elastically, and to have the electrical resistance of the circuit increase,
the layer being separate from the cap, a stretching of the cap which results from the tension-mounting thereof on the cushion does not lead to corresponding stretching of the layer,
however, due to the gluing of the layer on the cushion, all pressure communicated to the cushion by receiving an occupant is conveyed by a deformation of the cushion which is reverberated, through the gluing, on the layer which is found stretched with the increase of electrical resistance which results from this for the circuit; conversely, when the occupant removes themselves from the cushioning, the layer finds the non-stretched configuration thereof and the circuit, the original electrical resistance thereof.

According to a second aspect, the invention proposes a motor vehicle seat comprising such a cushioning.

According to a third aspect, the invention proposes a safety unit comprising such a seat.

### BRIEF DESCRIPTION OF THE DRAWING

Other particularities and advantages of the invention will appear in the following description, made in reference to the appended figures, wherein:

FIG. 1 is a schematic, partial, cross-sectional view of a cushioning according to one embodiment, the cushioning being mounted on a seat frame,

FIG. 2 is a schematic, front view of a layer according to one embodiment,

FIG. 3 is a schematic representation of a conductive ink.

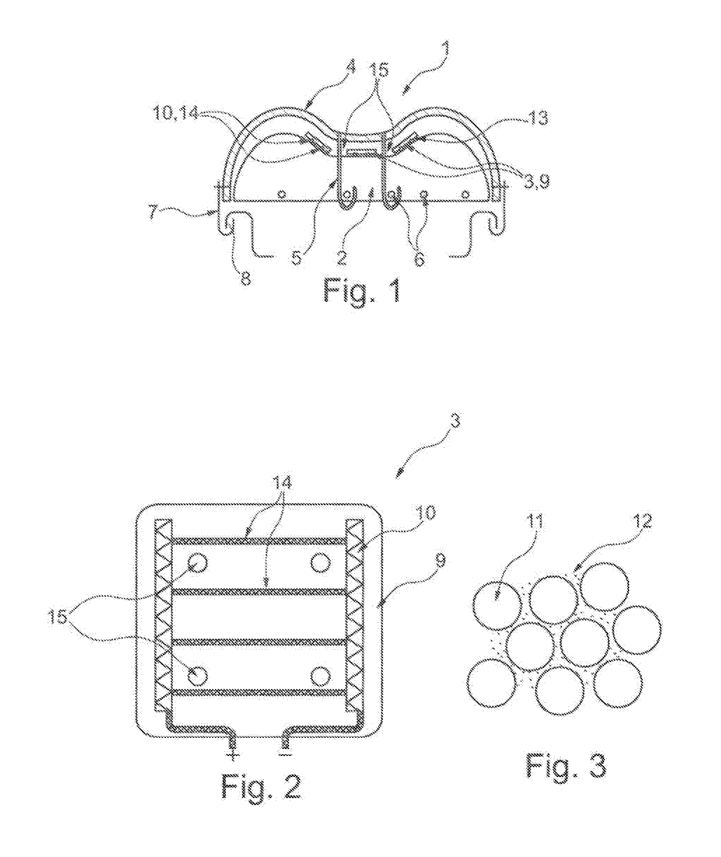

### DETAILED DESCRIPTION

In reference to the figures, a cushioning 1 is described in particular for seating or backrest for a motor vehicle seat, the cushioning comprising:
a padded cushion 2 made from foam—in particular polyurethane—elastically compressible,
a flexible layer 3 for detecting the presence of an occupant in the seat, the layer being arranged on the cushion on a face for receiving the occupant, the layer being made from a sheet 9 on which is printed—in particular by screen printing—an electric circuit 10 made from conductive ink, the ink being made from conductive particles 11—for example, metal—embedded in an elastically insulating binder 12—for example, made from polyurethane—the circuit being intended to be supplied by a generator,
a cap 4 covering the cushion, the cap being mounted on the cushion covering the layer, the cap being provided with return means 5—in this case, in the form of hooks—fastened on reciprocal means 6 secured to the cushion—in this case, being formed by fastening zones provided on a metal wire shaped by folding and overmoulded by the foam on the underside of the cushion—and peripheral fastening means 7—in this case, in the form of stitched profiles at the periphery of the cap, the profile having a hook-shaped profile—intended to cooperate with reciprocal means 8 outside of the cushioning provided on the seat—the external reciprocal means in this case being in the form of strips coming from the frame of the seat,

the cushioning furthermore having the following characteristics:
the sheet is elastically stretchable,
the layer is firstly separate from the cap and secondly glued, at least partially, by the underside of the sheet, to the cushion, to stretch when the cushion is deformed upon receiving an occupant, and to consequently stretch the circuit in such a way as to increase the electrical resistance of same.

It must be noted that the cap 4 being provided with return means 5 fastened on reciprocal means 6 secured to the cushion 2 and peripheral fastening means 7, this implies that the cap is not glued to the cushion.

According to one embodiment, the underside 13 of the sheet 9 is glued at least by one portion of the periphery thereof, along two opposite edges, on the cushion 2.

As an example, in the case of an electric circuit 10 comprising a filament network 14 extending transversally, as illustrated in FIG. 2, a gluing of the layer 3 by the lateral edges thereof on the cushion 2 can be provided, to observe the transversal stretching thereof when the cushioning 1 receives an occupant.

According to one embodiment variant, the underside 13 of the sheet 9 is glued totally on the cushion 2.

Such an arrangement can prove to be relevant when the electric circuit 10 has filaments 14 extending along multiple directions.

According to one embodiment, the sheet 9 is elastically stretchable in at least one direction of at least 5% with respect to the dimension thereof along the direction when it is not stretched.

According to one embodiment, the sheet 9 is made from textile, for example in the form of mesh.

It will be noted, that the sheet 9 must, of course, not have ink absorption properties during the deposition thereof—this by “blotting effect”—on penalty of not being able to produce the expected electric circuit 10.

According to the embodiment represented, the layer 3 has at least one orifice 15 for the passage of a return means 5 of the cap 4.

According to an embodiment not represented, the layer 3 comprises a plurality of electric circuits 10 mounted parallel, the circuits occupying, when the layer is seen from the front—i.e. from high in the case of a seating cushioning or from front in the case of a backrest cushioning—two separate zones of the cushioning 1.

According to one embodiment, the cushioning 1 is intended to form seating, the cushioning having a first front zone and a second rear zone, each receiving a respective front and rear circuit 10.

Such an arrangement can, in particular, make it possible to detect an increase in resistance of the front circuit 10 without increasing corresponding resistance for the rear circuit 10, indicating that the occupant of the cushioning 1 is too advanced towards the front to enable an airbag triggering likely to impact it.

Now, in a manner not represented, a motor vehicle seat comprising such a cushioning 1 is described, the cap 4 of the cushioning being fixed by the peripheral fastening means 7 thereof—in particular in the form of stitched profiles at the periphery of the cap, the profile having a hook-shaped profile—with reciprocal means 8 outside of the cushioning provided on the seat—the external reciprocal means being in particular in the form of strips coming from the frame of the seat.

Finally, in a manner not represented, a safety unit is described, comprising:
a seat such as described above,
a generator connected to the electric circuit 10,
a device for measuring the electrical resistance of the circuit, or of the sub-circuits thereof, under the effect of a pressure produced by an occupant on the cushioning 1,
a safety system, for example in the form of a warning light in case of seatbelt not fastened or also of an airbag,
a device for analysing the variation(s) in the resistance(s), the device being arranged to activate the safety system when predetermined activation conditions are fulfilled.

The analysis device can in particular be configured to detect the presence of an occupant on the cushioning 1, to activate, if necessary, a light detecting a non-fastening of their seatbelt, or also the triggering of an airbag in case of impact of the vehicle.

According to a more developed mode, the analysis device can analyse the position of the occupant on the cushioning 1, for example to obstruct, as stated above, the triggering of an airbag if the occupant is sat in a position that it too far forward on a seating cushioning 1.

What is claimed is:

1. A motor vehicle seat cushioning, the cushioning comprising:
a padded cushion made from elastically compressible foam,
a flexible layer adapted for detecting the presence of an occupant in the seat, the layer being arranged on the cushion on a face for receiving the occupant, the layer being made from a sheet on which an electric circuit made from conductive ink is printed, the ink being made from conductive particles embedded in an elastically insulating binder, the circuit being intended to be supplied by a generator,
a cap covering the cushion, the cap being mounted on the cushion covering the layer, the cap being provided with return means fastened on reciprocal means secured to the cushion and peripheral fastening means intended to cooperate with reciprocal means outside of the cushioning provided on the seat,
the cushioning wherein:
the sheet is elastically stretchable,
the layer is firstly separate from the cap and secondly glued, at least partially, by the underside of the sheet, to the cushion, adapted to stretch when the cushion is deformed upon receiving an occupant, and to consequently stretch the circuit in such a way as to increase the electrical resistance of same.

2. The cushioning according to claim 1, wherein the underside of the sheet is glued at least by one portion of the periphery of the cushioning, along two opposite edges, on the cushion.

3. The cushioning according to claim 1, wherein the underside of the sheet is glued totally on the cushion.

4. The cushioning according to claim 1, wherein the sheet is elastically stretchable in at least one direction by at least 5% with respect to the dimension of the cushioning along the direction when it is not stretched.

5. The cushioning according to claim 1, wherein the sheet is made from textile.

6. The cushioning according to claim 1, wherein the layer has at least one orifice for the passage of a return means of the cap.

7. The cushioning according to claim 1, wherein the layer comprises a plurality of electric circuits mounted in parallel, the circuits occupying, when the layer is seen from the front, two separate zones of the cushioning.

8. The cushioning according to claim 7, wherein the cushioning is intended to form seating, the cushioning having a first front zone and a second rear zone each receiving a respective front and rear circuit.

9. A motor vehicle seat comprising a cushioning according to claim 1, the cap of the cushioning being fixed by the peripheral fastening means of the cushioning to reciprocal means outside of the cushioning provided on the seat.

10. A safety unit comprising:
a seat according to claim 9,
a generator connected to the electric circuit,
a device for measuring the electrical resistance of the circuit, or the sub-circuits of the circuit, under the effect of a pressure produced by an occupant on the cushioning,
a safety system,
a device for analysing the variation(s) in the resistance(s), the device being arranged so as to activate the safety system when predetermined activation conditions are fulfilled.
